(19) United States
(12) Patent Application Publication
(10) Pub. No.: US 2004/0041940 A1
(43) Pub. Date: Mar. 4, 2004

(54) Process and apparatus for improving image contrast

(75) Inventor: Peter Zolliker, Dielsdorf (CH)

Correspondence Address: BURNS, DOANE, SWECKER & MATHIS, L.L.P., P.O. Box 1404, Alexandria, VA, 22313-1404, US

(73) Assignee: Imaging Solutions AG.

(21) Appl. No.: 10/442,935

(22) Filed: May 22, 2003

(30) Foreign Application Priority Data
May 23, 2002 (EP) 02 011 534.1

(51) Int. Cl. H04N 5/235

(52) U.S. Cl. 348/362

(57) ABSTRACT

Disclosed is a process for the correction of at least one exposure value of an image, whereby the exposure value of the image is corrected by use of a linearization function which depends on properties of an image capture device with which the image data were obtained. Further disclosed is an apparatus for the correction of exposure values including a data input device for the capture of image data and a processing unit for executing such a process.

### RELATED APPLICATIONS

This application claims priority under 35 U.S.C. §119 to a European Application 02 011 534.1 filed in Europe on May 23, 2002, the entire contents of which are hereby incorporated by reference in their entirety.

### BACKGROUND

1. Field

The invention relates to a process and an apparatus for improving the contrast of images, especially the improvement of the contrast of scanned, underexposed negatives with digital photo finishing systems.

2. Background Information

Underexposed negatives projected onto photographic paper generally have little contrast upon analogue image processing. By use of digital image processing, the contrast can principally be improved. Principally, different processes are known for digital contrast improvement.

According to one known process, the total contrast for a whole picture is increased on the basis of a measure of exposure. However, when such a process is used, the contrast of normally exposed or overexposed parts in a negative is increased to the same degree as that of the underexposed parts, which for certain images, for example underexposed flash images of people, has a negative influence on the picture quality.

Furthermore, a process for digital photo finishing is known from U.S. Pat. No. 6,233,069, in which an underexposure correction algorithm is used, whereby a digital image is shifted to a new position for the film minimum density values, an LUT (look-up table) is applied to the shifted digital image, and the digital image is thereafter reshifted to the original position for the film minimum density values.

It is generally disadvantageous to use algorithms which analyze the contrast worth improving of an individual image independent of the physical and/or chemical factors which contributed to the generation of this contrast and which based on the result, improve the contrast. When such algorithms are used, it can occur, for example, with images which because of their scene or intentionally include a region of low contrast, that the contrast is improperly increased.

### SUMMARY

The present invention is directed to a process and apparatus for the linearization or correction of exposure values, for example, the film density, especially for negative films, with which a most detail true copy can be achieved, preferably with improved contrast.

In general, the invention relates to the field of linearization or correction of exposure values, for example film densities, whereby the term “film density” is understood to be the log radiation density or light intensity, for example of a negative film scanned by a scanner. However, it is also possible to define brightness measurements other than the film density, for example even without the formation of the logarithm, as long as this film density enables a quantitative statement regarding the brightness or light strength.

For simplification, the invention is described by way of example only with reference to a negative film scanned by a scanner, whereby the invention generally can also be used, for example, for slides, digital image recordings or image data obtained with other systems in which specific exposure errors occur because of the process or the apparatus used for the generation of the picture.

Upon exposure of a film, a change occurs which is specific for the amount of light or the light intensity impinging on the film and which after development of the film becomes noticeable, for example as blackening or coloration of the film, whereby the film can be underexposed when the amount of light is too small, which means that an extremely small amount of light does not cause a change of the film, for example, by chemical or physical processes. When the amount of light is gradually increased, the film gradually changes starting with a certain amount of light or light intensity due to chemical and/or physical processes, and the degree of change or coloration or blackening of the film is larger the more light impinges on the film. The degree of change, for example chemical change, of the film which subsequently causes, for example, a blackening of a negative, is thereby in the little exposed or underexposed region not linear to the light density impinging on the film so that the function referred to as exposure curve, which represents the relationship between the light density and the film change or coloration or blackening, has a very low slope in the underexposed region close to the film mask.

FIG. 4 shows an example of an exposure curve of a film for red R, green G, and blue B.

Only for larger amounts of light impinging on the film is the degree of change, for example the blackening, of a film preferably about linear to the amount of impinging light, so that in that region a representation most true to detail can be achieved, whereby, for example, the degree of blackening of a film negative is about proportional to the amount of impinging light.

Exemplary embodiments of the invention avoid the non-linearity of the exposure curve at underexposure which leads to underexposed low contrast regions on negative films and thereby also on the prints or photos produced from the negatives.

In accordance with exemplary embodiments, at least one exposure value or a portion of an image data set, such as, for example, a measured film density of a scanned negative film, is corrected by using a linearization function which depends on the physical and/or chemical properties of an image capturing device, for example, the film used, the lens, or the like. A measured or modeled exposure curve can be used herefor, for example, by which a measured exposure value is converted into a corrected exposure value. Physical and/or chemical processes, can be taken into consideration such as, for example, the construction of a lens system, the transmission behavior of materials used, the reaction behavior of chemicals of a film, or, for example, when CCD's are used, the characteristic curves of the individual CCD elements which have an influence on the exposure curve or generally on the conversion of impinging light into image data and, for example, lead to a non-linear shape of the exposure curve. This nonlinear exposure curve is modeled according to one embodiment of the invention, for example, by direct measurement of the exposure curve over a range of exposure, which can span from a non-exposed region through an underexposed, a normally exposed and an overexposed region. The exposure curve measured in this way can be used either directly and, for example, stored in reference tables, or modeled or approximated using mathematical methods or functions, which can also be carried out in sections, in order to carry out a processing or correction of the exposure values by using this exposure curve which is determined by the chemical and/or physical properties of the processes involved in the image production. An image is to be obtained thereby which corresponds to reality, whereby a contrast improvement of the pictures can also be achieved by the linearization of the exposure curve, especially in the underexposed region.

A correction, for example of an underexposed region, can be carried out contrast independent and globally, which means no algorithms are used which produce local contrast improvements in limited regions of the picture, and for example, for an underexposure explicitly desired by a photographer, would lead to pictures which do not correspond to the idea of the photographer. The reason for the underexposure can be taken into consideration for the linearization or correction process to correct underexposed or also overexposed regions. It can be achieved that the same scene, which was captured with different exposure times has the same contrast after the correction and optionally additional processing steps, which is not at all the case or only to a limited extent with processes known from the prior art.

The log of the calibrated light intensity measured by a scanner can be used as exposure value, which is also referred to as film density. However, any process for the determination of a parameter or any measured parameter by which an exposure value can be quantitatively determined, can generally be used for the purposes of the invention, which means an exposure value used in accordance with exemplary embodiments of the invention must enable a quantitative assertion of a light amount or light intensity.

An inverse function of the exposure curve can be used for correction or linearization of exposure values. When the exposure curve represents the mapping of actual light or exposure values onto exposure values captured with or recorded on films, the actual exposure values can be reconstructed with the inverse function of this exposure curve from a given data material, such as, for example, a film negative.

The exposure curve and/or its inverse function can be approximated or estimated by curve shapes or mathematical functions, whereby different sections of the respective curve shapes determined, for example, by chemical and/or physical properties of the image capturing device, can be modeled by different functions best suited for the approximation.

The exposure curve and/or its inverse function can be divided into three sub ranges, as shown in the exemplary embodiment of FIG. 1. The function for the linearization or correction of exposure values in the normally exposed range shown as a continuous line in FIG. 1 extends above 1.4 linear with a slope of 1. In the singly underexposed range adjacent to the normally exposed range—from about 0.9 to 1.4 in FIG. 1—the curve is approximated by an atanh-function, which has the marginal parameters that it becomes singular at the film mask 0.8 and has the same slope as the adjacent linear portion in the sub-range adjacent to the linear range. The strongly underexposed range is modeled by a line with a slope sMax, which at the location adjacent the strongly underexposed range can be equal to the slope of the function used for the approximation of the singly underexposed range. The use of a straight line with preselected slope in the strongly underexposed range is advantageous, since noise, scratches or film graininess should not be increased to an undesirable degree. However, this limits the elevation of the exposure values in the strongly underexposed range.

In general, other mathematical functions can be used, for example, a linear function, functions described by polynomes, angular functions, exponential functions, inverse functions of those functions, combinations thereof, or also sectionwise defined functions.

The shape of the exposure curve and/or the curve or function for the correction or linearization of exposure values can be stored in a reference table LUT (lookup table), so that exposure values from over or underexposed ranges can be corrected with the use of values stored in the reference table. It is thereby advantageous to combine the reference table with the reference table that describes the logarithmizing and calibration of the intensities. Processor time can be saved herewith, since only one instead of two reference tables need be used for these processing steps.

Generally, processes in accordance with the invention can be used both for black and white pictures as well as color pictures, whereby, for example, three correction functions are used for the respective RGB values. These correction functions for Red, Green and Blue can, for example, have about the same shape. However, it is also possible to use different correction functions for the individual color values. Additionally, a correction function for black values can also be used with the same shape as, or a shape-specific for, black and white images.

The process can be used for the correction or processing of the exposure values of negative films, scanned, for example, by a scanner, slides, or otherwise stored image data. It is furthermore possible to use the process for the correction of exposure values of digitally recorded images, whereby in that case a linearization or correction function should correct the capturing errors specific for the digital image recording elements, such as, for example, CCD elements.

The invention further relates to a program which, when running on a computer or loaded into a computer causes the computer to carry out a process in accordance with the invention. In yet a further aspect, the invention provides a storage medium for the storage for of such a computer program.

According to another aspect, the invention provides an apparatus for the linearization and/or correction of exposure values, having an input device for the recording of digital image data signals and a processing unit which linearizes or corrects the captured image data signals in order to compensate for exposure errors, for example, to elevate the exposure values in underexposed ranges, and to thereby improve the contrast.

The data input device can be a scanner with which, for example, negative films or slides can be scanned and the image data present converted into digital data values.

Such a scanner can output, for example, to the processing unit, measured digitized data for the Red, Green and Blue values of a scanned original, in which the processing unit scanned image data values are corrected or processed by use of a linearization function and/or one or more reference tables (LUT's), to obtain linearized film densities.

The invention further relates to the use of a function and/or a reference table, which include information with regard to inaccuracies and/or non-linearities typical for a certain image capturing process and/or apparatus, for the linearization and/or correction of exposure values.

According to a further aspect, the invention provides a system for the correction or linearization of exposure values with an apparatus as described above and a device for the conversion of the corrected exposure values into output data which can be a device independent and with which photos or prints of the recorded images or image data can be produced. Reference is made to the embodiment described in FIG. 2 for an exemplary construction of such a conversion device, whereby an exemplary system in accordance with the invention can include one or more elements as shown in FIG. 2.

According to a another aspect, the invention provides a photo lab, especially a mini-lab or an apparatus for a large scale lab with a control device or a computer which, for example, carries out the above described process.

### BRIEF DESCRIPTION OF THE DRAWINGS

The invention will now be further described by way preferred embodiments with reference to the attached drawings, wherein

FIG. 1 shows a model for the linearization of measured film densities according to one embodiment of the invention;

FIG. 2 illustrates an exemplary system in accordance with the invention for the linearization of exposure values;

FIG. 3 shows examples of non-corrected images and images corrected in accordance with an exemplary embodiment of the invention; and

FIG. 4 is an exemplary exposure curve of a film.

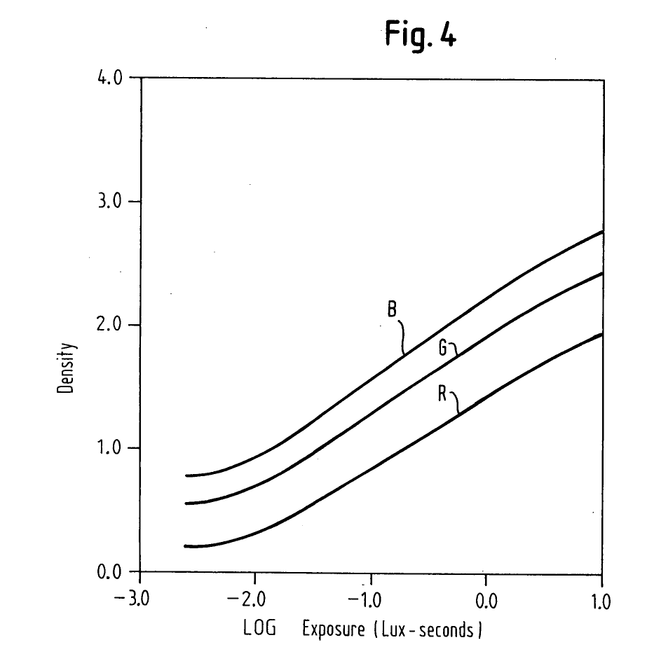

### DETAILED DESCRIPTION OF THE PREFERRED EMBODIMENTS

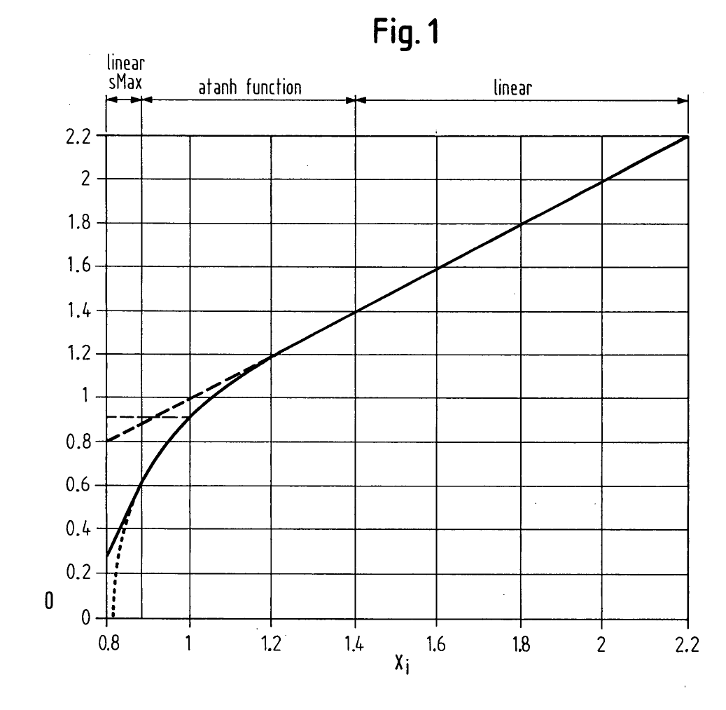

FIG. 1 shows an exemplary curve for the linearization of exposure data. In FIG. 1, the measured film density is plotted to the right, which is captured, for example, by a film scanner for negative films. An underexposed region of a negative is considered to be less blackened than a normally exposed region and can correspondingly be recalculated to obtain the film density values plotted above the axis extending to the right. In FIG. 1, an underexposed region is a region with low film density values. The value of the corrected or linearized film density is plotted upward, which means the value which should be obtained by use of the linearization function in accordance with an exemplary embodiment of the invention, when a measured film density value is available. The continuous line in FIG. 1 shows an exemplary function for the conversion of the measured film density values into corrected or linearized film density values. In the shown embodiment, this function is divided into three sub ranges, whereby, however, correction functions can also be used which are not divided into two ranges or into more than three ranges. Errors due to over-exposure can also be corrected, for example, by a correction function of suitable shape. The three exemplary illustrated ranges in which the shape of the correction function is approximated by different partial functions, are in the illustrated embodiment a strongly underexposed range, which extends up to a value of about 0.9 of the measured film density. In this range, the correction function is approximated by a straight line with a slope sMax, in order to not amplify noise, scratches or film graininess in an undesired manner. In the adjacent singly underexposed range, which in FIG. 1 lies between the film density values of 0.9 and 1.4, the correction function is approximated by an atanh-function, the slope of which at the value 0.9 is equal to sMax, the slope of the straight line for the strongly underexposed region, and becomes singular at the film mask. This atanh-function at the transition to the linear range at value 1.4 of the measured film density has the slope 1 and borders a straight line with the slope 1 which represents the correction function for the normally exposed linear range. In other words, a measured film density is translated 1:1 into a corrected film density in the normally exposed range, which means that, for example, the value 1.6 of the measured film density is mapped onto the value 1.6 of the corrected film density. In the singly underexposed range between 0.9 and 1.4, for example, the value 1 of the measured film density is mapped onto the value 0.9 of the corrected film density, which means a little exposed, for example, blackened region of a film negative leads to a high translucence and thereby high light density during scanning. In order to correct the underexposure, this high light density is reduced. In the strongly underexposed range, the correction is carried out by use of the above described straight line with the slope sMax, whereby the continuation of the atanh-function is shown as a broken line, which is not used, in order that, for example, scratches are not unnecessarily amplified.

The broken straight line adjacent to the linear region in FIG. 1 illustrates the function with which an ideal film would have to be exposed in order to then translate the correct measured film density into the same value of the processed film density, which means that a correction would not be necessary for an ideal film.

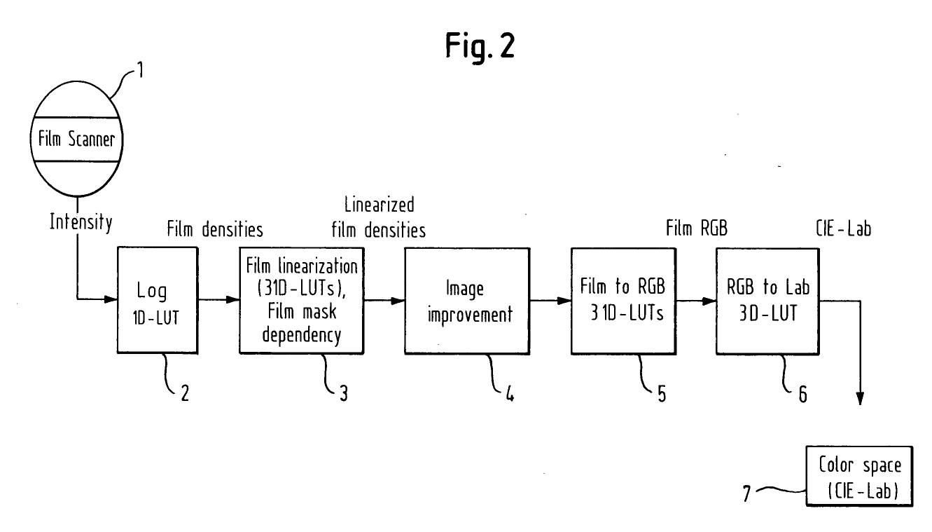

FIG. 2 illustrates a color processing system with a film scanner 1, a unidimensional reference table 1D-LUT 2, an exemplary apparatus 3 in accordance with the invention for the linearization or correction of exposure data, such as for the film linearization, an image improvement apparatus 4, an apparatus 5 for the translation of film densities into film RGB data, an apparatus 6 for the translation of RGB data into lab data and a device independent color space 7.

In an exemplary embodiment of the invention embodied in the apparatus 3, in combination with the reference table 2, the intensity of the exposure values measured by a film scanner 1, which already represent the logarithm are translated into film densities and transmitted to the apparatus 3 for the linearization and correction of the exposure values. Depending on the physical and/or chemical properties which lead to inaccuracy during the capture or exposure, three reference tables can be present for example in the apparatus 3 in dependence of different film masks. For example, the film density at the input of the reference table has the data range (0 . . . 4.095) and is divided into intervals of 0.001 film densities, which means the reference table has 4096 entries. The output delivers values in the range (−1.024 . . . 4.095). The curves typically have the same shape for Red, Green and Blue, but are shifted along the (x=y) -direction in such a way that the different film mask density is compensated. Typical mask densities are 0.8 for Blue, 0.6 for Green and 0.4 for Red.

Linearized values of the film density are output by the apparatus 3 to the apparatus 4 for the image improvement. Regarding the manner of operation of the apparatus 4, reference is made to EP 1 100 255 A2 of the applicant, the technical teachings of which regarding the manner of operation of the apparatus 4 are hereby incorporated by reference in their entirety. The apparatus 4 outputs corrected film densities to the apparatus 5 and 6, for the translation of the corrected film densities into film-RGB-data in the apparatus 5 using three reference tables, and for the further translation of those film-RGB-data into CIE-Lab data in the apparatus 6 using three reference tables which use a model of the paper used for the translation into the device independent color space 7 in known fashion. Regarding the manner of operation of the apparatus 5 and 6, reference is made to European patent application serial number 01 101 128.5 of the applicant, the teachings of which regarding the apparatus 5 and 6 are hereby incorporated herein by reference in their entireties.

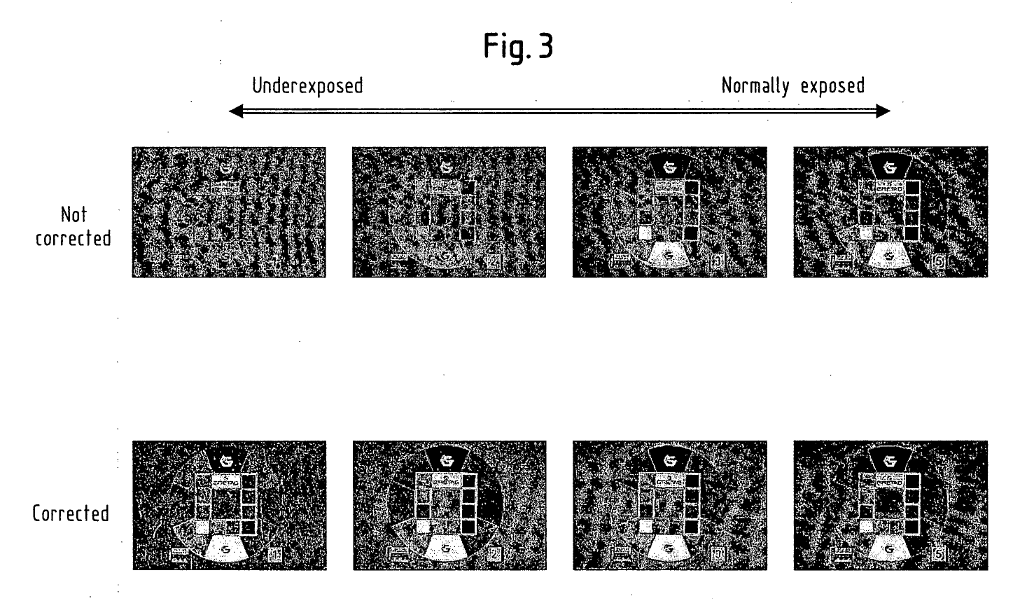

FIG. 3 illustrates in the upper half four images which were not corrected according to an exemplary embodiment of the invention, whereby starting from the normally exposed picture on the right, the three pictures to the left are increasingly underexposed. Pictures which were corrected in accordance with the exemplary embodiment of the invention and each have about the same contrast are shown under the respective uncorrected pictures. Only the corrected pictures produced from the strongly underexposed pictures have small interferences which are due to noise, scratches or film graininess.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. Process for correctiong at least one portion of an image data set, comprising:
obtaining image data of an image; and
correcting an exposure value of the image using a linearization function which is dependent on properties of an image capture apparatus with which the image data were obtained.

2. Process according to claim 1, whereby a measured film density is used as the exposure value.

3. Process according to claim 1, wherein the linearization function is formed from an inverse function of an exposure curve.

4. Process according to claim 3, wherein the linearization function is an approximation function of the inverse function of the exposure curve.

5. Process according to claim 1, wherein the linearization function includes different portions which are respectively described by different mathematical functions.

6. Process according to claim 1, wherein the linearization function is selected from the group of a linear function, a polynomial function, an angular function, an exponential function, an inverse function of these functions and any combination thereof.

7. Process according to claim 1, wherein the linearization function is stored in a reference table (LUT).

8. Process according to claim 1, wherein Red, Green and Blue values are corrected by one linearization function.

9. Process according to claim 1, wherein the image data are obtained from one of a scanned negative film, a slide, or a digital image capture device (CCD).

10. The process according to claim 1, comprising:
initiating the obtaining and correcting as a computer program loaded on a computer.

11. A computer program storage medium for containing the program according to claim 10.

12. Process according to claim 1, comprising:
using the linearization function which is dependent on the properties of at least one of the image capture apparatus and an image capture process, for correction or linearization of exposure data.

13. Apparatus for the correction of exposure data, comprising:
a data input device for obtaining of image data; and
a processing unit for correcting an exposure value of the image using a linearization function which is dependent on properties of an image capture apparatus with which the image data were obtained.

14. Apparatus according to claim 13, wherein the data input device is a scanner.

15. Apparatus according to claim 14, wherein the scanner scans negative films.

16. System for the translation of image data values into a device independent color space, comprising the apparatus according to claim 13.

17. Photo lab, comprising:
a data input device for obtaining image data of an image; and
a control device for correcting an exposure value of the image using a linearization function which is dependent on properties of an image capture apparatus with which the image data were obtained.

18. Photolab according to claim 17, selected from the group consisting of a minilab and an apparatus for a large scale lab.
